(19) United States
(12) Patent Application Publication
(10) Pub. No.: US 2008/0096997 A1
(43) Pub. Date: Apr. 24, 2008

(54) Amic acid ester oligomer precursor composition for polyimide resin containing the same, and uses

(76) Inventors: Chung-Jen Wu, Tainan City (TW); Chih-Ming An, Kaohsiung City (TW)

Correspondence Address: Hershkovitz & Associates, LLC, 2845 Duke Street, Alexandria, VA, 22314, US

(21) Appl. No.: 11/785,827

(22) Filed: Apr. 20, 2007

(30) Foreign Application Priority Data
Oct. 18, 2006 (TW) 095138481

(51) Int. Cl. C08G 69/26; C08F 2/46

(52) U.S. Cl. 522/36; 522/40; 528/183; 528/342

(57) ABSTRACT

The present invention provides an amic acid ester oligomer with the structure of formula (1)

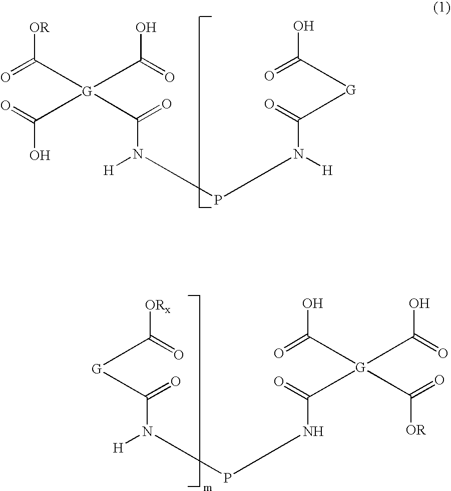

wherein R, Rₓ, G, P and m are as defined in the specification. The present invention also provides a precursor composition for a polyimide resin comprising the above-mentioned oligomer of formula (1). The polyimide synthesized from the precursor composition exhibits good operations and physiochemical properties.

### CROSS-REFERENCES TO RELATED APPLICATIONS

This application claims priority to Taiwan Patent Application No. 095138481 filed on Oct. 18, 2006, the entire specification of which is incorporated herein by specific reference thereto.

### FIELD OF THE INVENTION

The subject invention relates to a novel amic acid ester oligomer and a precursor composition for a polyimide containing the oligomer. The subject invention also relates to the use of the novel amic acid ester oligomer in the preparation of polyimide (PI).

### BACKGROUND OF THE INVENTION

Because polyimides have excellent thermal stability and good mechanical, electrical, and chemical properties, they have been used as high performance polymers. Moreover, semiconductor requirement standards have been raised as the use of conventional inorganic materials has become problematic and limited in application. The properties of polyimide can make up for the shortcomings of conventional materials in some aspects. Therefore, ever since the EI Du Pont Company developed the aromatic polyimide technology, polyimides have been used quite commonly and various applications thereof have been developed.

In the semiconductor industry, polyimide has been extensively used in passivating coatings, stress butter coatings, α-particle barriers, dry-etch masks, micromachines and interlayer dielectrics. Still, other uses are being developed. Polyimide is primarily used as the coating for protecting integrated circuit elements because the polyimide material is reliable as an integrated circuit element. Nonetheless, the polyimide has not only been used in the integrated circuit industry, but also in electronic packaging, enamelled wires, printed circuit boards, sensing elements, separating films, and structural materials.

The polyimide is typically synthesized with a two-stage polymerization and condensation reaction. Normally, in the first stage, an amine monomer is dissolved in a polar and aprotic solvent, such as N-methylpyrrolidone (NMP), N,N-dimethylacetamide (DMAC), dimethylformamide (DMF), or dimethyl sulfoxide (DMSO). An equal mole of a dianhydride monomer is then added. Afterwards, the condensation reaction is conducted at a low temperature or room temperature to form a precursor for the polyimide, i.e., poly(amic acid) (PAA).

In the second stage, the thermal imidization or chemical imidization is carried out for condensation, dehydration, and cyclization to convert the poly(amic acid) to polyimide.

The current reaction scheme for preparing the polyimide can be briefly described as follows:

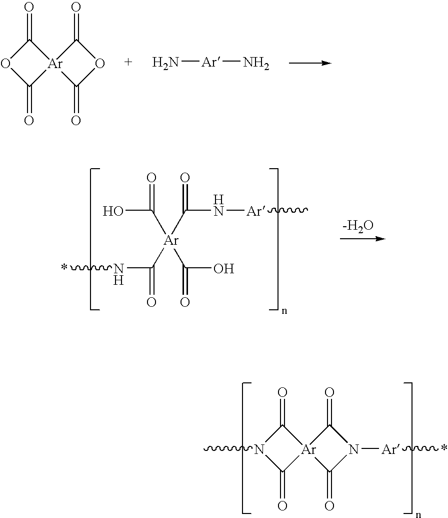

In the above preparation method, if the molecular weight of the poly(amic acid) obtained in the first stage does not reach a certain standard (i.e., overly low in molecular weight), a polyimide film with good physical properties cannot be obtained after imidization. However, if the poly(amic acid) obtained in the first stage is overly high in molecular weight, its viscosity will be too high such that its operability is poor. In addition, poor leveling occurs easily in the coating step. For example, during spin coating, the poor leveling phenomenon easily occurs. Moreover, if the poly(amic acid) is overly high in molecular weight, an extremely strong internal stress is produced due to the interaction between molecules and the shortening of molecular chains in the imidization of the second stage. The strong internal stress causes the coated substrate to bend and deform. In response to these problems, discussions have been submitted in many references for the relationship between the gradient curve of the rising temperature in the imidization of the second stage and the internal stress. Various approaches in decreasing the internal stress have been developed as well. Nonetheless, leveling problems and internal stress result from the overly high molecular weight of the poly(amic acid) obtained in the first stage. In other words, if the molecular weight of the poly(amic acid) can be well controlled, a polyimide film with excellent physical properties can be provided.

Furthermore, the poly(amic acid) is highly hygroscopic, such that the poly(amic acid) can easily react with water molecules and degrade thereafter. As a result, the poly(amic acid) cannot be easily stored.

Even though a useful polyimide has been greatly desired in this field, its material and operability are hardly considered at the same time. As a result, this invention strives to resolve the above-mentioned issues. Specifically, a polyimide film with the desired physical properties and operability is provided by a certain synthesis to meet the industrial need.

### SUMMARY OF THE INVENTION

One objective of the subject invention is to provide an amic acid ester oligomer bearing an ester end group (—C(O)OR) and a carboxyl end group (—C(O)OH).

Another objective of the subject invention is to provide a precursor composition for a polyimide comprising a diamine compound and an amic acid ester oligomer bearing an ester end group (—C(O)OR) and a carboxyl end group (—C(O)OH).

A further objective of the subject invention is to provide a polyimide which is obtained by the polymerization of the precursor composition for the polyimide of the subject invention.

### DESCRIPTION OF THE INVENTION

The amic acid ester oligomer of the subject invention has the following formula (1):

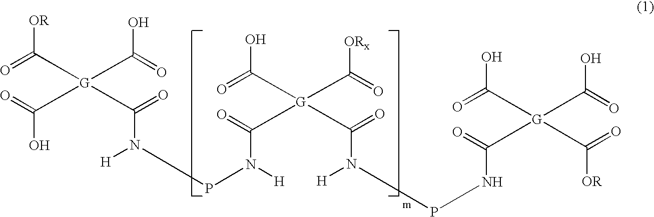

wherein
each R independently represents a linear or branched alkyl with 1 to 14 carbon atoms or an ethylenically unsaturated group;
each Rₓ independently represents H or a photo-polymerizable group;
each G independently represents a tetravalent organic group;
each P independently represents a divalent organic group; and
m is an integer from 0 to 100, preferably from 5 to 25.

In the embodiment of the above amic acid ester oligomer of formula (1), each R independently represents a linear or branched alkyl with 1 to 14 carbon atoms or an ethylenically unsaturated group. For example, the linear or branched alkyl with 1 to 14 carbon atoms can be:

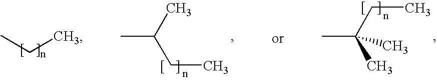

wherein n is an integer from 0 to 10. The linear or branched alkyl with 1 to 14 carbon atoms comprises (but is not limited to) methyl, ethyl, n-propyl, isopropyl, 1-methylpropyl, 2-methylpropyl, n-butyl, isobutyl, neobutyl, 1-methylbutyl, 2-methylbutyl, amyl, hexyl, heptyl, and octyl.

The ethylenically unsaturated group is not specified with any limitation and comprises (but is not limited to) vinyl, propenyl, methylpropenyl, n-butenyl, isobutenyl, vinylphenyl, propenylphenyl, propenyloxymethyl, propenyloxyethyl, propenyloxypropyl, propenyloxybutyl, propenyloxyamyl, propenyloxyhexyl, methylpropenyloxymethyl, methylpropenyloxyethyl, methylpropenyloxypropyl, methylpropenyloxybutyl, methylpropenyloxyamyl, and methylpropenyloxyhexyl, and a group of the following formula (2)

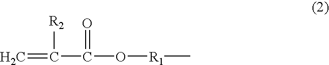

wherein, R₁ is phenylene, a linear or branched C₁-C₈ alkylene, a linear or branched C₂-C₈ alkenylene, a C₃-C₈ cycloalkylene, or a linear or branched C₁-C₈ hydroxyalkylene, and R₂ is H or a C₁-C₄ alkyl. The preferred group of formula (2) is

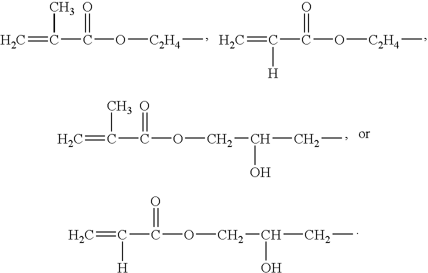

Each Rₓ in the amic acid ester oligomer of formula (1) of the subject invention independently represents H or any photo-polymerizable group. Preferably, the photo-polymerizable group is a group bearing an ethylenically unsaturated group. The ethylenically unsaturated group is described above. According to the subject invention, it is preferred that each Rₓ independently represents H, 2-hydroxypropyl methacrylate group (H₂CC(CH₃)C(O)OCH₂C(OH)HCH₂—), ethyl methacrylate group (H₂CC(CH₃)C(O)OCH₂CH—₂—), ethyl acrylate group (H₂CCHC(O)OCH₂CH₂—), propenyl, methylpropenyl, n-butenyl, or isobutenyl. More preferably, each Rₓ independently represents H or 2-hydroxypropyl methacrylate group

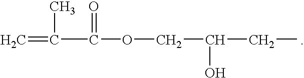

The tetravalent organic group G of the amic acid ester oligomer of formula (1) of the subject invention is not specified with any limitation. For example, it can be a tetravalent aromatic group or a tetravalent aliphatic group. The aromatic group can be monocyclic or polycyclic and is preferably selected from a group consisting of:

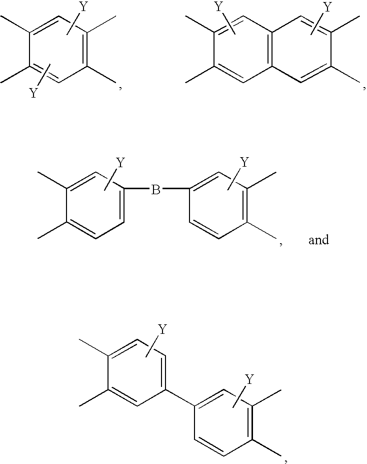

wherein each Y independently represents H, a halo group, —CF₃, or C₁-C₄ alkyl, and B represents —CH₂—, —O—, —S—, —CO—, —SO₂—, —C(CH₃)₂—, or —C(CF₃)₂—. More preferably, the aromatic group is selected from a group consisting of:

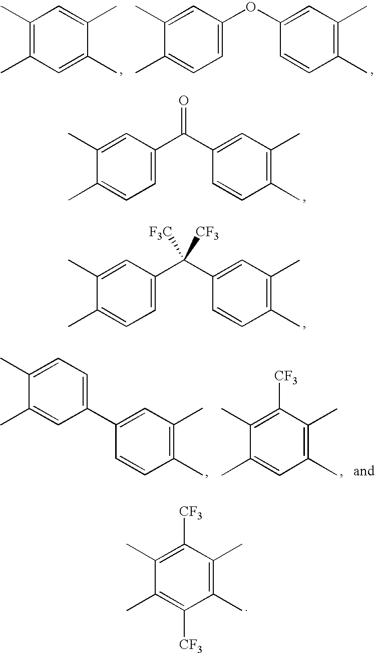

Moreover, the tetravalent aliphatic group can be selected from a group consisting of:

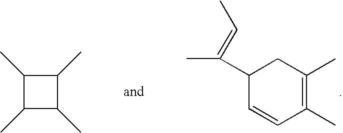

The divalent organic group P of the amic acid ester oligomer of formula (1) of the subject invention is not specified with any limitation. Generally, the divalent organic group P is an aromatic group, and preferably, independently represents:

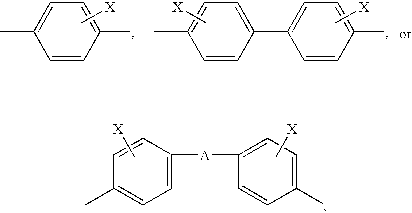

wherein, each X independently represents H, a halo group, C₁-C₄ alkyl, or C₁-C₄ perfluoroalkyl; A represents —O—, —S—, —CO—, —CH₂—, —OC(O)—, or —CONH—. More preferably, each divalent organic group P independently represents

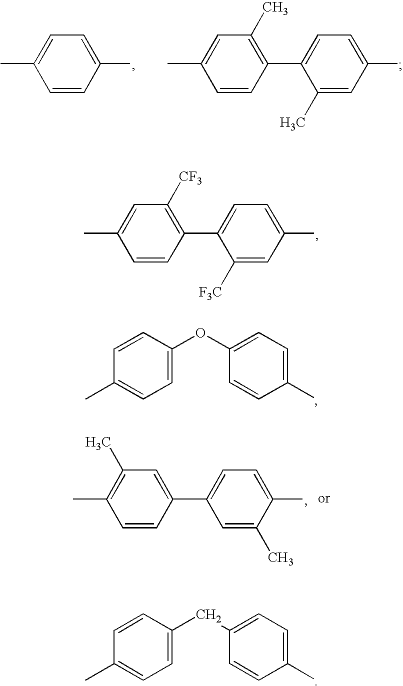

### In one embodiment, the divalent organic group P is

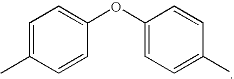

The divalent organic group P can also be a non-aromatic group, such as:

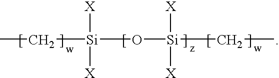

wherein X has the meaning as defined above, and each of w and z independently represents an integer ranging from 1 to 3. Preferably, the divalent organic group P is

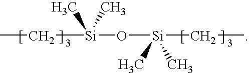

The inventors of the subject invention found that different from the conventional poly(amic acid) precursors for the preparation of polyimides, the amic acid ester oligomer of formula (1) has reduced acidic groups and thus is less hygroscopic. Even if the amic acid ester oligomer of formula (1) absorbs moisture, it is more stable and can be stored under room temperature. That is, it is unnecessary to store the precursor at a low temperature (e.g., —20° C.).

The amic acid ester oligomer of the subject invention can be polymerized in accordance with, but not limited to, the following procedures:
(a) reacting a dianhydride of formula (3) with a compound with hydroxyl (R—OH) to form a compound of formula (4), and

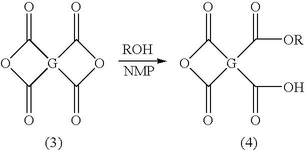

(b) adding a diamine compound of formula H₂N—Pₙ₁—NH₂ to the product obtained from step (a) to form an amic acid ester oligomer of formula (5) (if n1=1),

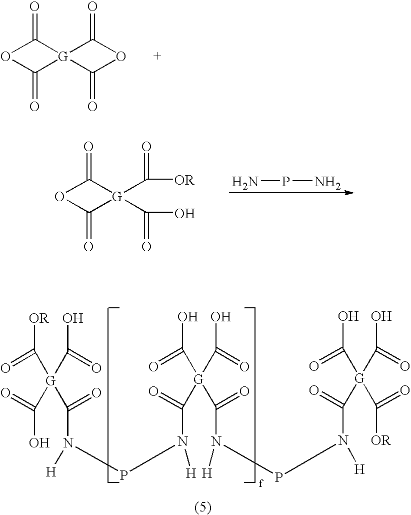

(c) optionally adding a monomer bearing a photo-polymerizable group (R*), e.g., epoxy acrylate, for conducting the reaction to form an amic acid ester oligomer of formula (6) (if n1=1),

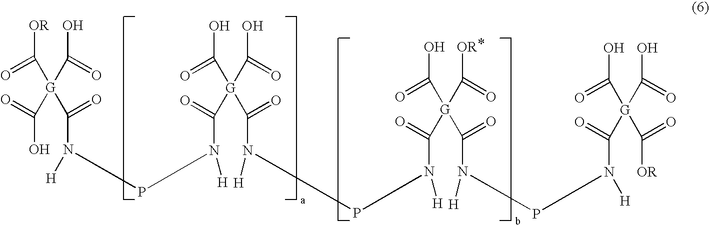

wherein R, G, P, and m are defined as the above; n1 is an integer ranging from 1 to 100, and preferably is 1; and each of a, b, and f independently represents an integer ranging from 0 to 100 and a+b≦100.

In the above process for preparing the amic acid ester oligomer of formula (1), the dianhydride used in step (a) can be aliphatic or aromatic, and is preferably aromatic. The example comprises (but is not limited to) pyromellitic dianhydride (PMDA), 4,4′-biphthalic anhydride (BPDA), 4,4′-hexafluoroisopropylidenediphthalic anhydride (6FDA), 1-(trifluoromethyl)-2,3,5,6-benzenetetracarboxylic dianhydride (P3FDA), 3,3′,4,4′-oxydiphthalic anhydride (ODPA), 1,4-bis(trifluoromethyl)-2,3,5,6-benzenetetracarboxylic dianhydride (P6FDA), 1-(3′,4′-dicarboxyphenyl)-1,3,3-trimethylindan-5,6-dicarboxylic dianhydride, 1-(3′,4′-dicarboxyphenyl)-1,3,3-trimethylindan-6,7-dicarboxylic dianhydride, 1-(3′,4′-dicarboxyphenyl)-3-methylindan-5,6-dicarboxylic dianhydride, 1-(3′,4′-dicarboxyphenyl)-3-methylindan-6,7-dicarboxylic dianhydride, 2,3,9,10-perylenetetracarboxylic dianhydride, 1,4,5,8-naphthalenetetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-2,4,5,8-tetracarboxylic dianhydride, phenanthrene-1,8,9,10-tetracarboxylic dianhydride, 3,3′,4,4′-benzophenonetetracarboxylic dianhydride, 1,2′,3,3′-benzophenonetetracarboxylic dianhydride, 3,3′,4,4′-biphenyltetracarboxylic dianhydride, 2,2′,3,3′-biphenyltetracarboxylic dianhydride, 4,4′-isopropylidenediphthalic anhydride, 3,3′-isopropylidenediphthalic anhydride, 4,4′-oxydiphthalic anhydride, 4,4′-sulfonyldiphthalic anhydride, 3,3′-oxydiphthalic anhydride, 4,4′-methylenediphthalic anhydride, 4,4′-thiodiphthalic anhydride, 4,4′-ethylidenediphthalic anhydride, 2,3,6,7-naphthalenetetracarboxylic dianhydride, 1,2,4,5-naphthalenetetracarboxylic dianhydride, 1,2,5,6-naphthalenetetracarboxylic dianhydride, benzene-1,2,3,4-tetracarboxylic dianhydride, pyrazine-2,3,5,6-tetracarboxylic dianhydride, and a combination thereof.

Preferably, the aromatic dianhydride used in step (a) is selected from a group consisting of: pyromellitic dianhydride (PMDA), 4,4′-biphthalic anhydride (BPDA), 4,4′-hexafluoroisopropylidenediphthalic anhydride (6FDA), 1-(trifluoromethyl)-2,3,5,6-benzenetetracarboxylic dianhydride (P3FDA), 1,4-bis(trifluoromethyl)-2,3,5,6-benzenetetracarboxylic dianhydride (P6FDA), benzophenonetetracarboxylic dianhydride (BTDA), 3,3′,4,4′-oxydiphthalic anhydride (ODPA), and a combination thereof. In one embodiment, pyromellitic dianhydride (PMDA) is used.

The compound with hydroxyl useful in the process of the subject invention for preparing the amic acid ester oligomer of formula (1) can be an alcohol, such as a monol, a diol, or a polyol, preferably a monol. The monol useful in the subject invention is not specified with any limitation and can be either a chain hydrocarbon alcohol, an aryl chain hydrocarbon alcohol, or an aryl alcohol. The monol can be (but is not limited to) a linear or branched alkyl alcohol with 1 to 14 carbon atoms. For example, the alkyl alcohol can be

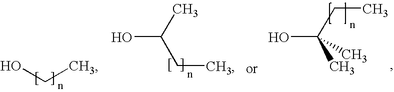

wherein n is an integer ranging from 1 to 10. In this case, the linear or branched alkyl alcohol with 1 to 14 carbon atoms comprises (but is not limited to) methanol, ethanol, n-propanol, isopropanol, 1-methylpropanol, 2-methylpropanol, n-butanol, isobutanol, neobutanol, 1-methylbutanol, 2-methylbutanol, pentanol, hexanol, heptanol, and octanol.

A compound with a hydroxyl group that is useful in the process of the subject invention can also bear a photo-polymerizable group, such as an ethylenically unsaturated group. Preferably, the compound has the following formula (7);

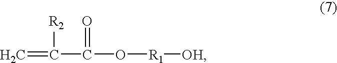

wherein R₁ is phenylene, a linear or branched C₁-C₈ alkylene, a linear or branched C₂-C₈ alkenylene, a C₃-C₈ cycloalkylene, or a linear or branched C₁-C₈ hydroxyalkylene; and R₂ is H or C₁-C₄ alkyl. Preferably, the compound of formula (7) is selected from a group consisting of: 2-hydroxyethyl acrylate (HEA), 2-hydroxyethyl methacrylate (HEMA), glycidyl methacrylate (GMA), glycidyl acrylate, and a combination thereof.

In the above process for preparing the amic acid ester oligomer of formula (1), the diamine used in step (b) is not specified with any limitation and normally is selected from aromatic diamines. The aromatic diamine useful in the process of the subject invention is well known by persons with ordinary skill in the art. For example, an aromatic diamine selected from the following group can be used in the preparation of the amic acid ester oligomer of the subject invention: 4,4′-diamino-diphenyl ether (ODA), para-phenylenediamine (pPDA), dimethyl-dibenzilidene (DMDB), para-bis(trifluoromethyl)-benzilidine (TFMB), 3,3′-dimethyl-4,4′-diaminobiphenyl (oTLD), 4,4′-octafluorobenzidine (OFB), tetrafluorophenylenediamine (TFPD), 2,2′,5,5′-tetrachlorobenzidine (TCB), 3,3′-dichlorobenzidine (DCB), 2,2′-bis(3-aminophenyl)hexafluoropropane, 2,2′-bis(4-aminophenyl)hexafluoropropane, 4,4′-oxo-bis(3-trifluoromethyl)aniline, 3,5-diaminobenzotrifluoride, tetrafluorophenylene diamine, tetrafluoro-m-phenylene diamine, 1,4-bis(4-aminophenoxy-2-tertbutylbenzene (BATB), 2,2′-dimethyl-4,4′-bis(4-aminophenoxy)biphenyl (DBAPB), 2,2-bis[4-(4-aminophenoxy)phenyl]hexafluoropropane (BAPPH), 2,2′-bis[4-(4-aminophenoxy)phenyl]norborane (BAPN), 5-amino-1-(4′-aminophenyl)-1,3,3-trimethylindane, 6-amino-1-(4′-aminophenyl)-1,3,3-trimethylindane, 4,4′-methylenebis(o-chloroaniline), 3,3′-dichlorobenzidine (DCB), 3,3′-sulfonyldianiline, 4,4′-diaminobenzophenone, 1,5-diaminonaphthalene, bis(4-aminophenyl)diethyl silane, bis(4-aminophenyl)diphenyl silane, bis(4-aminophenyl)ethyl phosphine oxide, N-(bis(4-aminophenyl)-N-methyl amine, N-(bis(4-aminophenyl))-N-phenyl amine, 4,4′-methylenebis(2-methylaniline), 4,4′-methylenebis(2-methoxyaniline), 5,5′-methylenebis(2-aminophenol), 4,4′-methylenebis(2-methylaniline), 4,4′-oxybis(2-methoxyaniline), 4,4′-oxybis(2-chloroaniline), 2,2′-bis(4-aminophenol), 5,5′-oxybis(2-aminophenol), 4,4′-thiobis(2-methylaniline), 4,4′-thiobis(2-methoxyaniline), 4,4′-thiobis(2-chloroaniline), 4,4′-sulfonylbis(2-methylaniline), 4,4′-sulfonylbis(2-ethoxyaniline), 4,4′-sulfonylbis(2-chloroaniline), 5,5′-sulfonylbis(2-aminophenol), 3,3′-dimethyl-4,4′-diaminobenzophenone, 3,3′-dimethoxy-4,4′-diaminobenzophenone, 3,3′-dichloro-4,4′-diaminobenzophenone, 4,4′-diaminobiphenyl, m-phenylenediamine, 4,4-methylenedianiline (MDA), 4,4′-thiodianiline, 4,4′-sulfonyldianiline, 4,4′-isopropylidenedianiline, 3,3′-dimethoxybenzidine, 3,3′-dicarboxybenzidine, 2,4-tolyl-diamine, 2,5-tolyl-diamine, 2,6-tolyl-diamine, m-xylyldiamine, 2,4-diamino-5-chloro-toluene, 2,4-diamino-6-chloro-toluene, and a combination thereof. Preferably, the diamine is selected from 4,4′-diamino-diphenyl ether (ODA), para-phenylenediamine (pPDA), dimethyl-dibenzilidene (DMDB), para-bis(trifluoromethyl)-benzilidine (TFMB), 3,3′-dimethyl-4,4′-diaminobiphenyl (oTLD), 4,4′-methylenedianiline (MDA), and a combination thereof.

Preferably, the diamine used in step (b) is selected from a group consisting of:

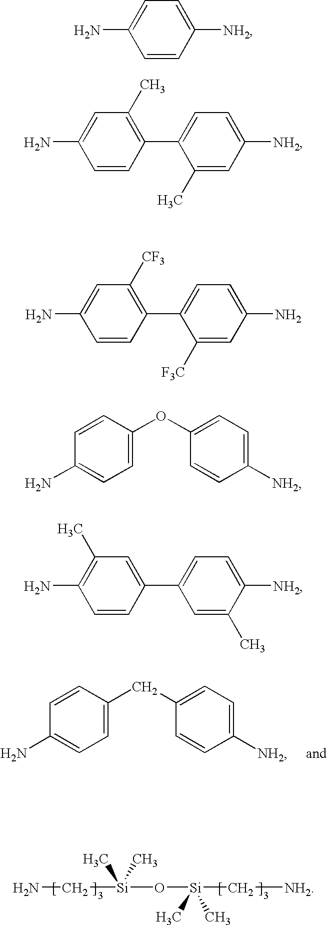

As mentioned above, a monomer bearing a photo-polymerizable group can be optionally added to step (c) to add a photo-polymerizable group to the amic acid ester oligomer. Specifically, if the monomer with the photo-polymerizable group is not added, the Rₓ of the amic acid ester oligomer of formula (1) represents an H. If the monomer with a photo-polymerizable group is added, Rₓ of the amic acid ester oligomer of formula (1) represents a photo-polymerizable group. In the case of Rₓ being a photo-polymerizable group, the chemical bond between the molecules forms a crosslink in the course of the subsequent process for synthesizing polyimide.

The subject invention further provides a precursor composition for a polyimide comprising an amic acid ester oligomer of formula (1):

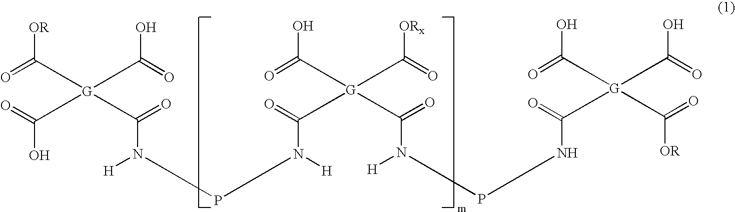

and a diamine compound of formula H₂N—Pₙ₁—NH₂. The total molar ratio of the amic acid ester oligomer of formula (1) to the diamine compound ranges from about 0.8:1 to about 1.2:1. R, Rₓ, G, P, m and n1 have the meanings as defined above. The afore-mentioned diamine is not specified with any limitation and can be a monomer, oligomer, or polymer, preferably a monomer. The diamine compound can be selected from a group consisting of:

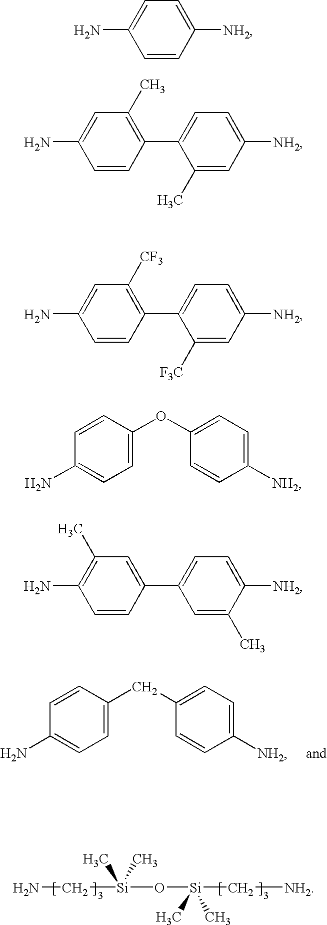

In the composition of the subject invention, the total molar ratio of the amic acid ester oligomer to the diamine compound is preferred to range from about 0.9:1 to about 1.1:1. The amic acid ester oligomer of formula (1) can be prepared using the afore-mentioned process.

The composition of the subject invention further comprises a solvent, preferably a polar and aprotic solvent. The polar and aprotic solvent can be selected from (but is not limited to) a group consisting of: N-methylpyrrolidone (NMP), N,N-dimethylacetamide (DMAC), N,N-dimethylformamide (DMF), dimethyl sulfoxide (DMSO), toluene, xylene, and a combination thereof.

In the composition of the subject invention, based on the total weight of the entire precursor composition, the amount of the amic acid ester oligomer ranges from about 15% to about 55%, preferably from about 30% to about 40%; the amount of the diamine compound ranges from about 0.1% to about 25%, preferably from about 0.2% to about 20%, and the amount of the solvent ranges from about 20% to about 80%, preferably from about 45% to about 75%.

The composition of the subject invention can optionally comprise any additives known by persons skilled in the art, such as a photoinitiator, silane coupling agent, leveling agent, stabilizer, catalyst, and/or defoaming agent.

The photoinitiator suitable for the subject invention is not specified with any limitation and can be selected from a group consisting of: benzophenone, benzoin, 2-hydroxy-2-methyl-1-phenyl-propan-1-one, 2,2-dimethoxy-1,2-diphenylethan-1-one, 1-hydroxy cyclohexylphenyl ketone, 2,4,6-trimethylbenzoyl diphenyl phosphine oxide, N-phenylglycine, 9-phenylacridine, benzyldimethylketal, 4,4′-bis(diethylamino)dipehenyl ketone, 2,4,5-triarylimidazole dimmers, or a combination thereof, preferably benzophenone. Specifically, based on the total weight of the precursor composition of the subject invention, the amount of the photoinitiator ranges from about 0.01 to about 20 wt %, preferably from about 0.1 to about 5 wt %.

Common silane coupling agents are selected from (but are not limited to) a group consisting of: 3-aminopropyltrimethoxysilane, 3-aminopropyltriethoxysilane, 2-aminopropyltrimethoxysilane, 2-aminopropyltriethoxysilane, and a combination thereof.

The subject invention also provides a polyimide, which is prepared by the polymerization of an amic acid ester oligomer of formula (1) and a diamine compound of the formula H₂N—Pₙ₁—NH₂:

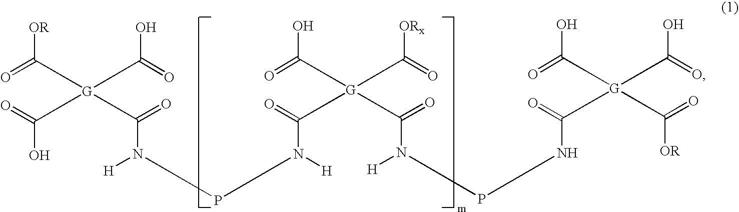

wherein R, Rₓ, G, P, m, and n1 have the meanings as defined above. The total molar ratio of the amic acid ester oligomer of formula (1) to the diamine compound ranges from about 0.8:1 to about 1.2:1, preferably from about 0.9:1 to about 1.1:1. The afore-mentioned diamine compound is not specified with any limitation and can be a monomer, oligomer, or polymer, preferably a monomer.

The process for the polymerization of the polyimide of the subject invention can be conducted in accordance with (but not limited to) the scheme shown below:

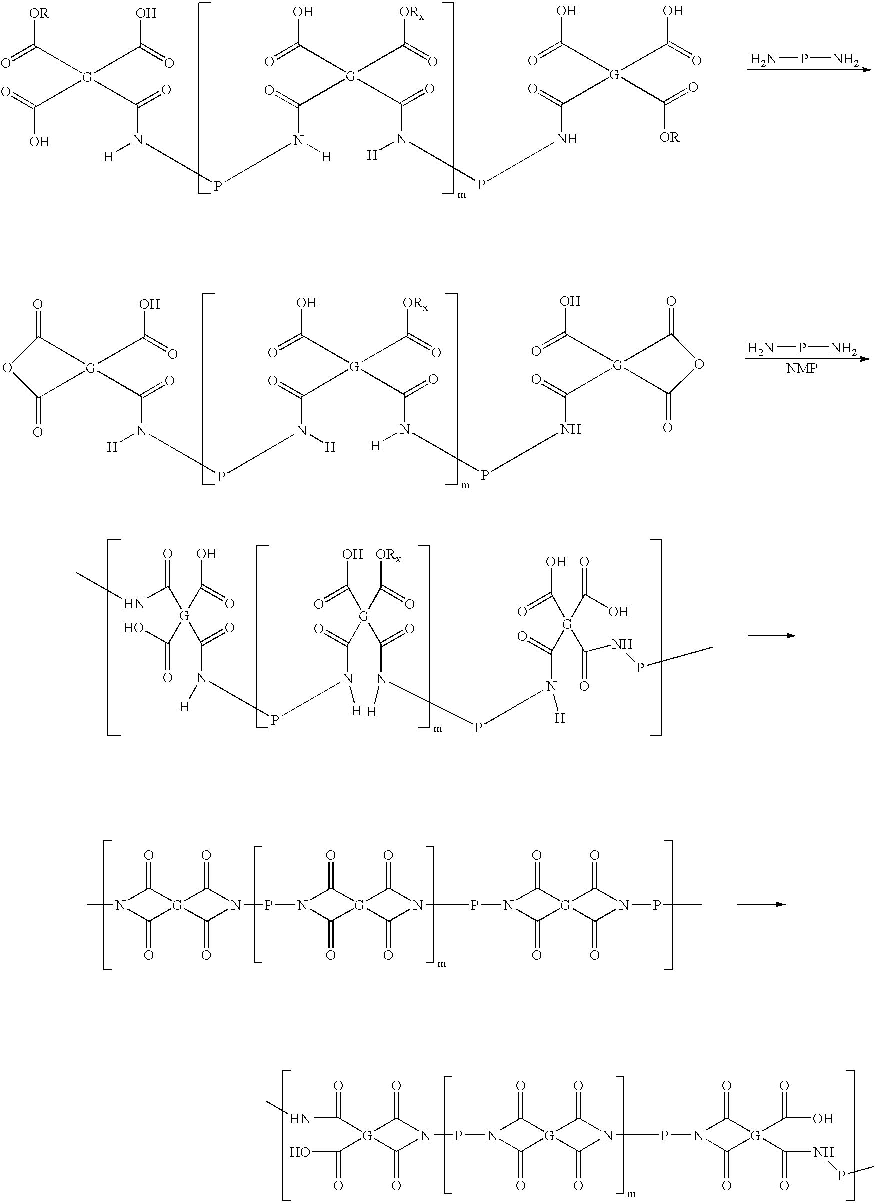

In the synthesis of polyimide used in the prior art, it is necessary to synthesize poly(amic acid) with a higher molecular weight as the precursor. However, because of the excessively high molecular weight and high viscosity resulting therefrom, the operability is poor and leveling problems easily occur during coating. Moreover, the excessively high molecular weight of poly(amic acid) causes extreme interior stress resulting from the interaction between molecules and the molecular chain reductions during the polyimidization of the precursor. The extreme interior stress causes bending and deformation of the coated substrate. Also, according to the prior polyimide synthesis, the solid content of the poly(amic acid) formed via polymerization only results in a yield between about 10% and about 30%, and thus, the volume shrinkable ratio after cyclization is higher. As a result, the coating procedure must be repeated many times to attain the desired thickness of the product and enhance the processing difficulty.

The polyimide of the subject invention is produced by the polymerization of an amic acid ester oligomer and a diamine compound, which is characterized by the ester end group (—C(O)OR) and a carboxyl end group (—C(O)OH) that is in a meta stable status and thus will not react with the diamine compound at room temperature. Also, since the amic acid ester oligomer has a low molecular weight, its operability is good and can maintain a leveling effect during coating. During post-curing, after the temperature is raised to above 100° C., the (—C(O)OR) and (—C(O)OH) end groups are reduced by the diamine compound to an anhydride and then the reaction is conducted to form amic acid ester oligomers. Afterwards, the oligomers are further polymerized to form molecules with higher molecular weight for subsequent condensation to provide a polyimide with excellent thermal property, mechanical property, and tensile property. As compared with the prior art, the subject invention utilizes an amic acid ester oligomer with lower viscosity as a precursor to the preparation of the polyimide, not a high molecular weight poly(amic acid) with higher viscosity. Thus, the polyimide of the subject invention exhibits better leveling property and operability when being coated.

The polyimide of the subject invention is further characterized in that during the polyimidization of the precursor composition, the amic acid ester oligomers are intramolecularly cyclized prior to the polymerization and cyclization between the molecules. This reaction order effectively reduces the interior stress in the polyimide. As compared with the prior art, the polyimide cyclized from the precursor composition of the subject invention doesn't bend.

Since the precursor composition for polyimide of the subject invention has a high solid content, the amount of the solvent used can be reduced to shorten the baking time and reduce the baking temperature. Also, the rate for drying the film formed is faster and the number of times of coating for attaining the desired thickness of the product is reduced.

In a further aspect, the curing temperature for preparing polyimide generally up to 300 to 350° C. in the prior art. However, the precursor composition of the subject invention can be cured at a temperature ranging from about 200° C. to 250° C. to further decrease the operating cost.

Furthermore, some monomers or short chain oligomers are typically added to the polymerization to allow crosslinking between molecules. However, since the precursor composition of the subject invention comprises a photo-polymerizable group, it can self-crosslink during the curing step. Therefore, the precursor composition of the subject invention does not require additional unsaturated monomers or oligomers and is advantageous in comparison with the prior art in this aspect.

As shown in the following examples, the polyimide provided by the subject invention exhibits better thermal property, mechanical property, and tensile property than those prepared from the prior technology.

### EXAMPLES

Examples 1 to 20 illustrate the steps and conditions for preparing the composition for polyimide of the subject invention. Comparative example 1 relates to the composition for a polyimide prepared by the prior technology.

### Example 1

2.181 g (0.01 mol) of pyromellitic dianhydride (PMDA) was dissolved in 200 g of N-methyl-2-pyrrolidinone (NMP). The mixture was heated to 50° C. and stirred for 2 hours. 1.161 g (0.01 mol) of 2-hydroxyethyl acrylate (HEA) was slowly dropped into the mixture and stirred for 2 hours at 50° C. Then, 18.018 g (0.09 mol) of 4,4′-diamino-diphenyl ether (ODA) was added to the solution. After complete dissolution, 18.0216 g (0.09 mol) of PMDA was added and stirred for 6 hours at 50° C. Lastly, 2.0024 g (0.01 mol) of ODA was added and the mixture was stirred for 1 hour.

### Comparative Example 1

20.024 g (0.1 mol) of ODA was dissolved in 200 g of NMP, and then the mixture was placed in an ice bath of 0° C. while stirring for 1 hour. Then, 0.29 g (0.002 mol) of phthalic anhydride was added and stirred for 1 hour. Then, 21.59 g (0.099 mol) of PMDA was slowly added and stirred for 12 hours.

### Example 2

2.181 g (0.01 mol) of PMDA was dissolved in 200 g of NMP. The mixture was heated to 50° C. and stirred for 2 hours. 13.01 g (0.01 mol) of 2-hydroxyethyl methacrylate (HEMA) was slowly dropped into the mixture and stirred for 2 hours at 50° C. Then, 18.018 g (0.09 mol) of ODA was added to the solution. After complete dissolution, 18.0216 g (0.09 mol) of PMDA was added and stirred for 6 hours at 50° C. Lastly, 2.0024 g (0.01 mol) of ODA was added and stirred for 1 hour.

### Example 3

2.181 g (0.01 mol) of PMDA was dissolved in 200 g of NMP. The mixture was heated to 50° C. and stirred for 2 hours. 1.161 g (0.01 mol) of HEA was slowly dropped into the mixture and stirred for 2 hours at 50° C. Then, 9.733 g (0.09 mol) of para-phenylenediamine (pPDA) was added to the solution. After complete dissolution, 18.0216 g (0.09 mol) of PMDA was added and stirred for 6 hours at 50° C. Lastly, 1.0814 g (0.01 mol) of pPDA was added and stirred for 1 hour.

### Example 4

2.181 g (0.01 mol) of PMDA was dissolved in 200 g of NMP. The mixture was heated to 50° C. and stirred for 2 hours. 13.01 g (0.01 mol) of HEMA was slowly dropped into the mixture and stirred for 2 hours at 50° C. Then, 9.733 g (0.09 mol) of pPDA was added to the solution. After complete dissolution, 18.0216 g (0.09 mol) of PMDA was added stirred for 6 hours at 50° C. Lastly, 1.0814 g (0.01 mol) of pPDA was added and stirred for 1 hour.

### Example 5

2.181 g (0.01 mol) of PMDA was dissolved in 200 g of NMP. The mixture was heated to 50° C. and stirred for 2 hours. 1.161 g (0.01 mol) of HEA was slowly dropped into the mixture and the reaction stirred for 2 hours at 50° C. Then, 19.1065 g (0.09 mol) of dimethyl-dibenzilidene (DMDB) was added to the solution. After complete dissolution, 18.0216 g (0.09 mol) of PMDA was added and stirred for 6 hours at 50° C. Lastly, 2.123 g (0.01 mol) of DMDB was added and stirred for 1 hour.

### Example 6

2.181 g (0.01 mol) of PMDA was dissolved in 200 g of NMP. The mixture was heated to 50° C. and stirred for 2 hours. 13.01 g (0.01 mol) of HEMA was slowly dropped into the mixture and stirred for 2 hours at 50° C. Then, 19.1065 g (0.09 mol) of DMDB was added to the solution. After complete dissolution, 18.0216 g (0.09 mol) of PMDA was added and stirred for 6 hours at 50° C. Lastly, 2.123 g (0.01 mol) of DMDB was added and stirred for 1 hour.

### Example 7

2.181 g (0.01 mol) of PMDA was dissolved in 200 g of NMP. The mixture was heated to 50° C. and stirred for 2 hours. 1.161 g (0.01 mol) of HEA was slowly dropped into the mixture and stirred for 2 hours at 50° C. Then, 19.1065 g (0.09 mol) of 3,3′-dimethyl-4,4′-diaminobiphenyl (oTLD) was added to the solution. After complete dissolution, 18.0216 g (0.09 mol) of PMDA was added and stirred for 6 hours at 50° C. Lastly, 2.123 g (0.01 mol) of oTLD was added and stirred for 1 hour.

### Example 8

2.181 g (0.01 mol) of PMDA was dissolved in 200 g of NMP. The mixture was heated to 50° C. and stirred for 2 hours. 13.01 g (0.01 mol) of HEMA was slowly dropped into the mixture and stirred 2 hours at 50° C. Then, 19.1065 g (0.09 mol) of oTLD was added to the solution. After complete dissolution, 18.0216 g (0.09 mol) of PMDA was added and stirred for 6 hours at 50° C. Lastly, 2.123 g (0.01 mol) of oTLD was added and stirred for 1 hour.

### Example 9

2.181 g (0.01 mol) of PMDA was dissolved in 200 g of NMP. The mixture was heated to 50° C. and stirred for 2 hours. 1.161 g (0.01 mol) of HEA was slowly dropped into the mixture and stirred for 2 hours at 50° C. Then, 28.821 g (0.09 mol) of para-bis(trifluoromethyl)-benzilidine (TFMB) was added to the solution. After the complete dissolution, 18.0216 g (0.09 mol) of PMDA was added and stirred for 6 hours at 50° C. Lastly, 3.202 g (0.01 mol) of TFMB was added and stirred for 1 hour.

### Example 10

2.181 g (0.01 mol) of PMDA was dissolved in 200 g of NMP. The mixture was heated to 50° C. and stirred for 2 hours. 13.01 g (0.01 mol) of HEMA was slowly dropped into the mixture and stirred for 2 hours at 50° C. Then, 28.821 g (0.09 mol) of TFMB was added to the solution. After complete dissolution, 18.0216 g (0.09 mol) of PMDA was added and stirred for 6 hours at 50° C. Lastly, 3.202 g (0.01 mol) of TFMB was added and stirred for 1 hour.

### Example 11

2.181 g (0.01 mol) of PMDA was dissolved in 200 g of NMP. The mixture was heated to 50° C. stirred for 2 hours. 0.32 g (0.01 mol) of methanol was slowly dropped into the mixture and stirred for 2 hours at 50° C. Then, 18.018 g (0.09 mol) of ODA was added to the solution. After complete dissolution, 18.0216 g (0.09 mol) of PMDA was added and stirred for 6 hours at 50° C. Lastly, 2.0024 g (0.01 mol) of ODA was added and stirred for 1 hour.

### Example 12

2.181 g (0.01 mol) of PMDA was dissolved in 200 g of NMP. The mixture was heated to 50° C. and stirred for 2 hours. 0.601 g (0.01 mol) of isopropanol was slowly dropped into the mixture and stirred for 2 hours at 50° C. Then, 18.018 g (0.09 mol) of ODA was added to the solution. After complete dissolution, 18.0216 g (0.09 mol) of PMDA was added and stirred for 6 hours at 50° C. Lastly, 2.0024 g (0.01 mol) of ODA was added and the mixture was stirred for 1 hour.

### Example 13

2.181 g (0.01 mol) of PMDA was dissolved in 200 g of NMP. The mixture was heated to 50° C. and stirred for 2 hours. 0.32 g (0.01 mol) of methanol was slowly dropped into the mixture and stirred for 2 hours at 50° C. Then, 9.733 g (0.09 mol) of para-phenylenediamine (pPDA) was added to the solution. After complete dissolution, 18.0216 g (0.09 mol) of PMDA was added and stirred for 6 hours at 50° C. Lastly, 1.0814 g (0.01 mol) of pPDA was added and the mixture was stirred for 1 hour.

### Example 14

2.181 g (0.01 mol) of PMDA was dissolved in 200 g of NMP. The mixture was heated to 50° C. and stirred for 2 hours. 0.601 g (0.01 mol) of isopropanol was slowly dropped into the mixture and stirred for 2 hours at 50° C. Then, 9.733 g (0.09 mol) of pPDA was added to the solution. After complete dissolution, 18.0216 g (0.09 mol) of PMDA was added and stirred for 6 hours at 50° C. Lastly, 1.0814 g (0.01 mol) of pPDA was added and the mixture was stirred for 1 hour.

### Example 15

2.181 g (0.01 mol) of PMDA was dissolved in 200 g of NMP. The mixture was heated to 50° C. and stirred for 2 hours. 10.32 g (0.01 mol) of methanol was slowly dropped into the mixture and stirred for 2 hours at 50° C. Then, 19.1065 g (0.09 mol) of dimethyl-dibenzilidene (DMDB) was added to the solution. After complete dissolution, 18.0216 g (0.09 mol) of PMDA was added and stirred for 6 hours at 50° C. Lastly, 2.123 g (0.01 mol) of DMDB was added and the mixture was stirred for 1 hour.

### Example 16

2.181 g (0.01 mol) of PMDA was dissolved in 200 g of NMP. The mixture was heated to 50° C. and stirred for 2 hours. 0.601 g (0.01 mol) of isopropanol was slowly dropped into the mixture and stirred for 2 hours at 50° C. Then, 19.1065 g (0.09 mol) of DMDB was added to the solution. After complete dissolution, 18.0216 g (0.09 mol) of PMDA was added and stirred for 6 hours at 50° C. Lastly, 2.123 g (0.01 mol) of DMDB was added and the mixture was stirred for 1 hour.

### Example 17

2.181 g (0.01 mol) of PMDA was dissolved in 200 g of NMP. The mixture was heated to 50° C. stirred for 2 hours. 0.32 g (0.01 mol) of methanol was slowly dropped into the mixture stirred for 2 hours at 50° C. Then, 19.1065 g (0.09 mol) of 3,3′-dimethyl-4,4′-diaminobiphenyl (oTLD) was added to the solution. After complete dissolution, 18.0216 g (0.09 mol) of PMDA was added stirred for 6 hours at 50° C. Lastly, 2.123 g (0.01 mol) of oTLD was added and the mixture was stirred for 1 hour.

### Example 18

2.181 g (0.01 mol) of PMDA was dissolved in 200 g of NMP. The mixture was heated to 50° C. and stirred for 2 hours. 0.601 g (0.01 mol) of isopropanol was slowly dropped into the mixture stirred for 2 hours at 50° C. Then, 19.1065 g (0.09 mol) of oTLD was added to the solution. After complete dissolution, 18.0216 g (0.09 mol) of PMDA was added and stirred for 6 hours at 50° C. Lastly, 2.123 g (0.01 mol) of oTLD was added and the mixture was stirred for 1 hour.

### Example 19

2.181 g (0.01 mol) of PMDA was dissolved in 200 g of NMP. The mixture was heated to 50° C. and stirred for 2 hours. 0.32 g (0.01 mol) of methanol was slowly dropped into the mixture and stirred for 2 hours at 50° C. Then, 28.821 g (0.09 mol) of para-bis(trifluoromethyl)-benzilidine (TFMB) was added to the solution. After the completion of dissolution, 18.0216 g (0.09 mol) of PMDA was added and stirred for 6 hours at 50° C. Lastly, 3.202 g (0.01 mol) of TFMB was added and the mixture was stirred for 1 hour.

### Example 20

2.181 g (0.01 mol) of PMDA was dissolved in 200 g of NMP. The mixture was heated to 50° C. and stirred for 2 hours. 0.601 g (0.01 mol) of isopropanol was slowly dropped into the mixture and stirred for 2 hours at 50° C. Then, 28.821 g (0.09 mol) of TFMB was added to the solution. After complete dissolution, 18.0216 g (0.09 mol) of PMDA was added and stirred for 6 hours at 50° C. Lastly, 3.202 g (0.01 mol) of TFMB was added and the mixture was stirred for 1 hour.

### Test of the Physical Property of Polyimide

The relevant data of the molecular weights of polyimides produced were tested by the HT-GPC instrument (Waters Model:2010) and listed in Table 1.

TABLE 1

| Sample | Mₙ | M_{w} | MP⁽¹⁾ | PD⁽²⁾ |
|---|---|---|---|---|
| The subject invention | 16,129 | 23,530 | 21,238 | 1.458866 |
| (Example 1) | | | | |
| Prior art | 106,828 | 263,324 | 266,462 | 2.464926 |
| (Comparative | | | | |
| Example 1) | | | | |

⁽¹⁾peak value of molecular weight
⁽²⁾polydispersity

It can be found from the data in Table 1 that the subject invention can provide a polyimide with a lower polydispersity, i.e., with a narrower molecular weight distribution and a smaller difference between high molecular weight and low molecular weight, indicating a better quality.

The compositions of Example 1 and Comparative Example 1 were cured to obtain polyimides. The polymer materials were formed into films by spin coating. Next, the films were baked in an oven in three stages, 150° C./60 min, 250° C./60 min, and 350° C./60 min at a heating rate of 2° C./min, and then cooled. The physical property was then tested.

Afterwards, the mechanical property of the polyimide film was tested by a universal tension machine (High Temperature Bending Test Apparatus, Model 9102, produced by Hon-Tai Company) The polyimide film was cut into a shape with dimensions 12 cm×10 cm×0.25 mm and then put on the universal tension machine. The test was conducted at a temperature of 23° C. and a rate of 10 mm/min. The polyimide films prepared from the compositions of Example 1 and Comparative Example 1 were separately tested to measure the tensile strength. The results were listed in Table 2.

TABLE 2

| | Tensile | Elongation |
|---|---|---|
| Sample | strength (MPa) | percent (%) |
| The subject invention | 78.896 | 11.185 |
| (Example 1) | | |
| Prior art | 74.3 | 5.415 |
| (Comparative Example 1) | | |

It can be found from the results in Table 2 that the polyimide film of the subject invention exhibits superior tensile strength and elongation.

The above examples are intended to illustrate the embodiments of the subject invention and explicate its technical feature, but not to limit the scope of protection of the subject invention. Any modifications or equal replacements that can be easily accomplished by persons skilled in this field belong to the scope claimed by the subject invention. The scope of protection of the subject invention should be on the basis of the following claims as appended.

What is claimed is:

1. An amic acid ester oligomer of formula (1): 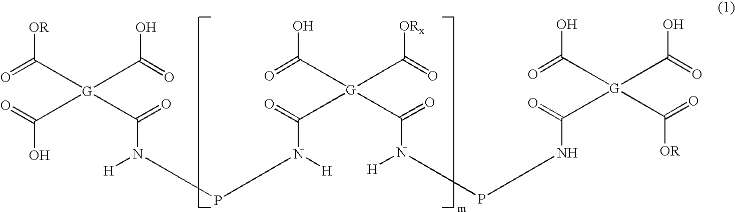
wherein
each Rₓ independently represents H or an enthylenically unsaturated group;
each G independently represents a tetravalent organic group;
each P independently represents a divalent organic group;
m is an integer ranging from 0 to 100; and
each R independently represents linear or branched alkyl with 1 to 14 carbon atoms or an ethylenically unsaturated group

2. The amic acid ester oligomer of claim 1, wherein the enthylenically unsaturated group is selected from a group consisting of: vinyl, propenyl, methylpropenyl, n-butenyl, isobutenyl, vinylphenyl, propenylphenyl, propenyloxymethyl, propenyloxyethyl, propenyloxypropyl, propenyloxybutyl, propenyloxyamyl, propenyloxyhexyl, methylpropenyloxymethyl, methylpropenyloxyethyl, methylpropenyloxypropyl, methylpropenyloxybutyl, methylpropenyloxyamyl and methylpropenyloxyhexyl, and a group of formula (2) 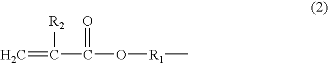
wherein, R₂ is H or C₁-C₄ alkyl and R₁ is phenylene or a linear or branched C₁-C₈ alkylene, linear or branched C₂-C₈ alkenylene, C₃-C₈ cycloalkylene, or a linear or branched C₁-C₈ hydroxyalkylene.

3. The amic acid ester oligomer of claim 1, wherein each Rₓ independently represents H, 2-hydroxypropyl methacrylate group (H₂CC(CH₃)C(O)OCH₂C(OH)HCH₂—), ethyl methacrylate group (H₂CC(CH₃)C(O)OCH₂CH₂—), ethyl acrylate group (H₂CCHC(O)OCH₂CH₂—), propenyl, methylpropenyl, n-butenyl, or isobutenyl.

4. The amic acid ester oligomer of claim 1, wherein each Rₓ independently represents H or 2-hydroxypropyl methacrylate group (H₂CC(CH₃)C(O)OCH₂CH₂—).

5. The amic acid ester oligomer of claim 1, wherein the tetravalent organic group is selected from a group consisting of: 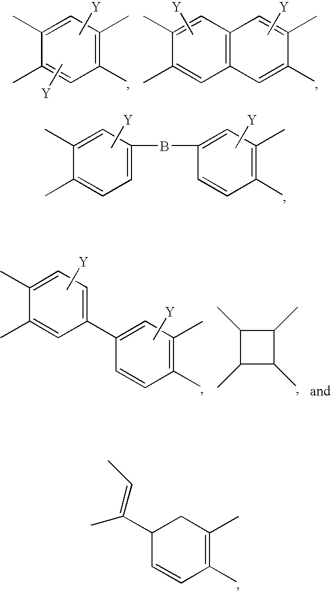
wherein each Y independently represents H, a halo group, —CF₃, or C₁-C₄ alkyl, and B is —CH₂—, —O—, —S—, —CO—, —SO₂—, —C(CH₃)₂—, or —C(CF₃)₂—.

6. The amic acid ester oligomer of claim 5, wherein the tetravalent organic group is selected from a group consisting of:

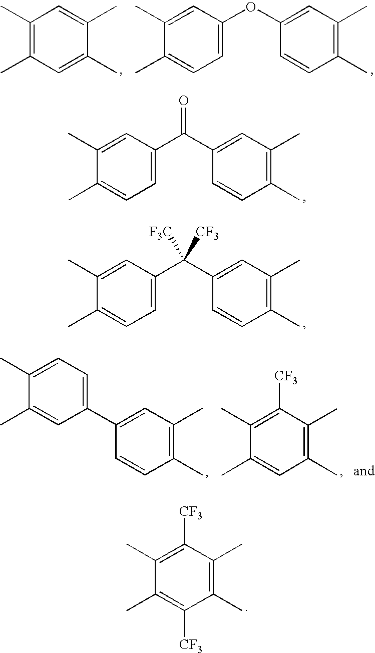

7. The amic acid ester oligomer of claim 1, wherein the divalent organic group is selected from a group consisting of: 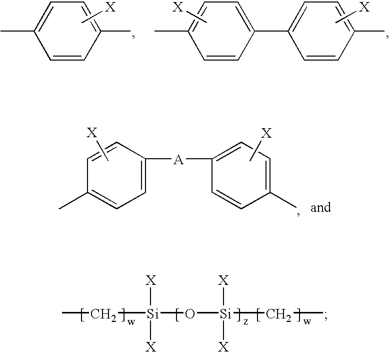
wherein each X independently represents H, a halo group, C₁-C₄ alkyl, or C₁-C₄ perfluoroalkyl; A is —O—, —S—, —CO—, —CH₂—, —OC(O)—, or —CONH—; and each of w and z independently represents an integral ranging from 1 to 3.

8. The amic acid ester oligomer of claim 7, wherein the divalent organic group is selected from a group consisting of:

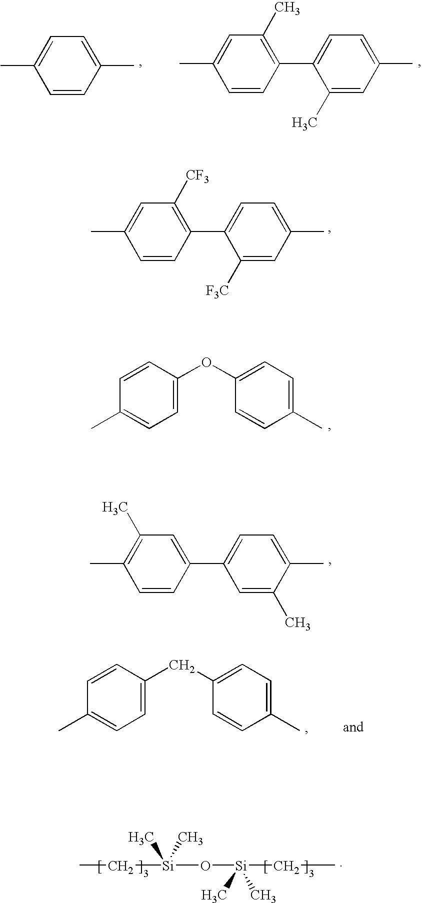

9. The amic acid ester oligomer of claim 1, wherein m is an integral ranging from 5 to 25.

10. The amic acid ester oligomer of claim 1, wherein R is selected from a group consisting of: 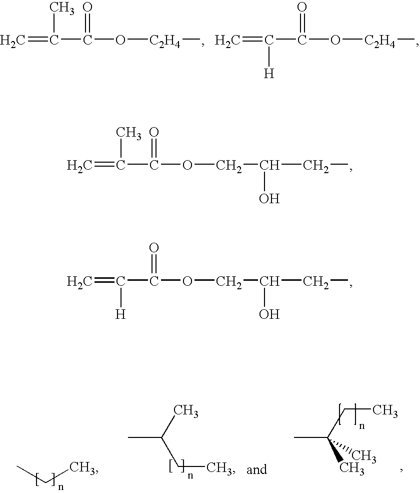
wherein n is an integral ranging from 0 to 10.

11. A precursor composition for polyimide, comprising an amic acid ester oligomer of formula (1) 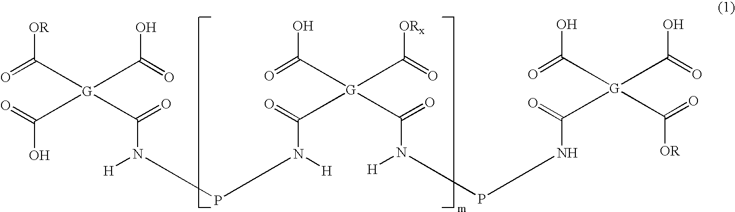
and a diamine compound, the total molar ratio of the amic acid ester oligomer of formula (1) to the diamine compound being from about 0.8:1 to about 1.2:1, wherein R, Rₓ, G, P, and m have the meanings defined in claim 1.

12. The composition of claim 11, wherein the total molar ratio of the amic acid ester oligomer of formula (1) to the diamine compound is from about 0.9:1 to about 1.1:1.

13. The composition of claim 11, wherein the diamine compound is selected from a group consisting of:

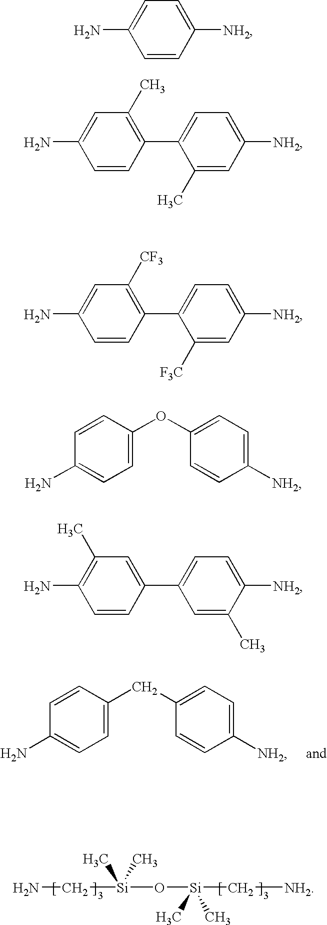

14. The composition of claim 11, further comprising a solvent selected from a group consisting of: N-methylpyrrolidone (NMP), N,N-dimethylacetamide (DMAC), N,N-dimethylformamide (DMF), dimethyl sulfoxide (DMSO), toluene, xylene, and a combination thereof.

15. The composition of claim 11, further comprising a photoinitiator selected from a group consisting of: benzophenone, benzoin, 2-hydroxy-2-methyl-1-phenyl-propan-1-one, 2,2-dimethoxy-1,2-diphenyl-ethan-1-one, 1-hydroxy cyclohexyl phenyl ketone, 2,4,6-trimethylbenzoyl diphenyl phosphine oxide, N-phenylglycine, 9-phenylacridine, benzyldimethylketal, 4,4′-bis(diethylamino)dipehenyl ketone, 2,4,5-triarylimidazole dimmers, and a combination thereof.

16. A polyimide which is obtained by polymerizing an amic acid ester oligomer of formula (1) and a diamine compound 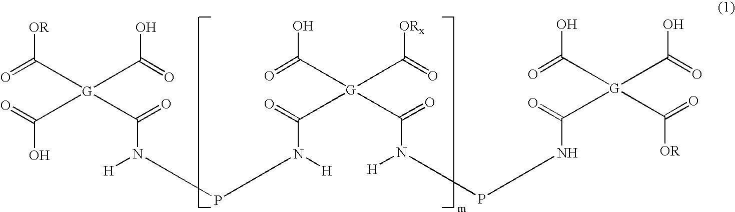
wherein the total molar ratio of the amic acid ester oligomer of formula (1) to the diamine compound is from about 0.8:1 to about 1.2:1 and R, Rₓ, G, P, and m have the meanings defined in claim 1.

17. The polyimide of claim 16, wherein the total molar ratio of the amic acid ester oligomer of formula (1) to the diamine compound is from about 0.9:1 to about 1.1:1.
